(19) United States
(12) Patent Application Publication
(10) Pub. No.: US 2017/0048022 A1
(43) Pub. Date: Feb. 16, 2017

(54) TRANSMISSION DEVICE, TRANSMISSION SYSTEM AND TRANSMISSION METHOD

(71) Applicant: FUJITSU LIMITED, Kawasaki-shi (JP)

(72) Inventor: Gen KAINO, Kawasaki (JP)

(73) Assignee: FUJITSU LIMITED, Kawasaki-shi (JP)

(21) Appl. No.: 15/227,239

(22) Filed: Aug. 3, 2016

(30) Foreign Application Priority Data
Aug. 12, 2015 (JP) 2015-159629

(51) Int. Cl. H04L 1/00

(52) U.S. Cl. CPC H04L 1/0045; H04L 1/0041; H04L 1/0061

(57) ABSTRACT

There is provided a transmission device including a receiver configured to receive a frame into which control information and a data signal are mapped; a de-mapper configured to de-map the control information and the data signal from the frame received by the receiver; a hardware processor configured to acquire a numerical value related to the frequency of the data signal from the control information de-mapped by the de-mapper, and output an alarm in response to a variation of the numerical value for the frame; and a regenerator configured to regenerate the data signal de-mapped by the de-mapper with a frequency based on the numerical value acquired by the hardware processor.

### CROSS-REFERENCE TO RELATED APPLICATION

This application is based upon and claims the benefit of priority of the prior Japanese Patent Application No. 2015-159629, filed on Aug. 12, 2015, the entire contents of which are incorporated herein by reference.

### FIELD

The embodiments discussed herein are related to a transmission device, a transmission system, and a transmission method.

### BACKGROUND

With the increase in communication demand, high-speed optical transmission systems have been standardized. For example, the International Telecommunication Union Telecommunication Standardization Sector (ITU-T) Recommendation G.709 specifies technologies for an optical transport network (OTN) of about 1.25 Gbps to 100 Gbps.

An OTN transmission system enables large-capacity transmission since a plurality of client signals are multiplexed in an optical channel transport unit (OTU) frame to be transmitted. Examples of the client signals may include, for example, a synchronous digital hierarchy (SDH) frame, a synchronous optical network (SONET) frame, and an Ethernet® frame.

In addition, numerical information about frequencies of the client signals is stored in an overhead of the OTU frame. A transmission device receiving the OTU frame regenerates the client signals based on the numerical information and transmits the client signals to another network.

The numerical information is protected by a cyclic redundancy check (CRC) code (see, e.g., Japanese Laid-Open Patent Publication Nos. 05-176017 and 05-063683) within the overhead. The transmission device compares the value of the CRC code and a CRC value calculated from the numerical information and detects an error of the numerical information when the CRC code value and the CRC value are not coincide with each other.

Related techniques are disclosed in, for example, Japanese Laid-Open Patent Publication No. 05-176017 and Japanese Laid-Open Patent Publication No. 05-063683.

### SUMMARY

According to an aspect of the invention, a transmission device includes: a receiver configured to receive a frame into which control information and a data signal are mapped; a de-mapper configured to de-map the control information and the data signal from the frame received by the receiver; a hardware processor configured to acquire a numerical value related to the frequency of the data signal from the control information de-mapped by the de-mapper, and output an alarm in response to a variation of the numerical value for the frame; and a regenerator configured to regenerate the data signal de-mapped by the de-mapper with a frequency based on the numerical value acquired by the hardware processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a transmission system according to a first embodiment;

FIG. 2 is a block diagram illustrating transmission devices according to the first embodiment;

FIG. 3 is a block diagram illustrating an OTU frame according to the first embodiment;

FIG. 4 is a flow chart (1) illustrating an exemplary process of outputting an alarm according to the first embodiment;

FIG. 5 is a flow chart (2) illustrating an exemplary process of outputting an alarm according to the first embodiment;

FIG. 6 is a table illustrating one example of parameters;

FIG. 7A is a view illustrating one example of numerical values Cn(t), Cm(t), and CnD(t) and an accumulated value ΣCnD(t) in a normal state;

FIG. 7B is a view illustrating one example of an accumulated value ΣCnD(t) in an abnormal state;

FIG. 8A is a view illustrating one example of numerical values Cn(t), Cm(t), and CnD(t) and an accumulated value ΣCnD(t) in a normal state;

FIG. 8B is a view illustrating one example of numerical values Cn(t) and Cm(t) in an abnormal state;

FIG. 9 is a flow chart illustrating one example of a system switching process of a network management device;

FIG. 10 is a block diagram illustrating a transmission system according to a second embodiment;

FIG. 11 is a block diagram illustrating a transmission device according to the second embodiment;

FIG. 12 is a block diagram illustrating an OTU frame according to the second embodiment;

FIG. 13 is a view illustrating one example of numerical values Cn(t), Cm(t), and CnD(t) and an accumulated value ΣCnD(t); and

FIG. 14 is a flow chart illustrating an exemplary process of outputting an alarm according to the second embodiment.

### DESCRIPTION OF EMBODIMENTS

According to a CRC, there are some cases where an error is not detected in a case where ‘0’ is consecutively arranged in the beginning of data to be protected. Therefore, in a case where a receiving side transmission device cannot detect an error of a main signal as an alarm (e.g., a burst error of 3 msec or less), if the transmission device cannot detect an error of numerical information about frequencies of the client signals stored in the overhead of the OTU frame, by using the CRC, there occurs a deviation in a frequency for reproducing a client signal and accordingly an error occurs in the client signal that is being transmitted.

A specified time constant is set in a phase locked loop (PLL) within an oscillator which generates the frequency of the client signal in the receiving side transmission device. Therefore, once the frequency is deviated, it takes a relatively long time to return to the original frequency. Therefore, the error of the client signal lasts for a long time (e.g., about 10 seconds) and it takes a relatively long time as well to restore the error.

This problem has a great impact on communication services when a transmission rate of a main signal is high as in the OTN. However, this problem is not limited to the OTN but exists in transmitters of different types.

Hereinafter, techniques for reducing the time taken to restore an error of a transmitting signal which is caused by a frequency deviation will be described with reference to the accompanying drawings.

### First Embodiment

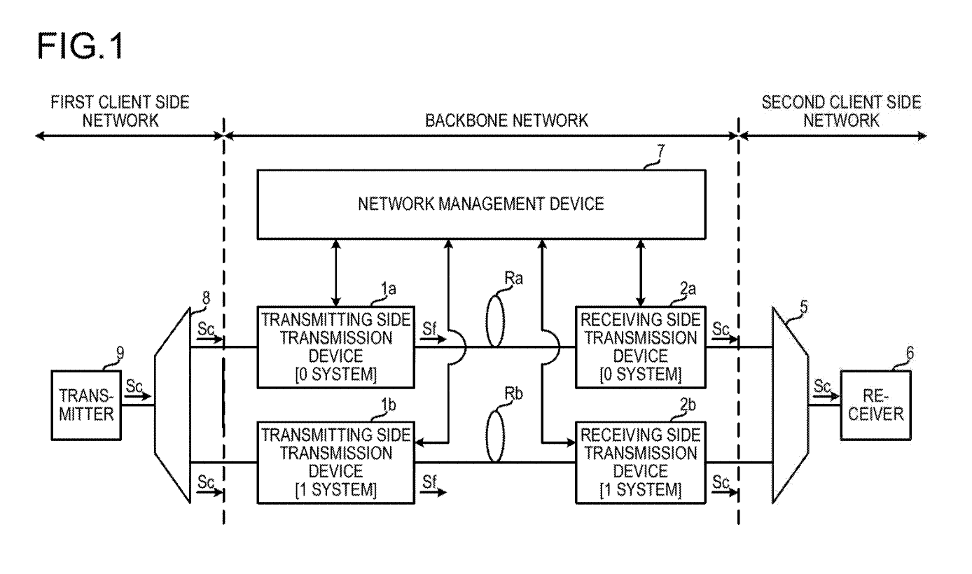

FIG. 1 is a block diagram illustrating a transmission system according to a first embodiment. The transmission system includes one set of transmitting side transmission devices 1a and 1b, one set of receiving side transmission devices 2a and 2b, a transmitter 9, a de-multiplexer 8, a multiplexer 5, a receiver 6, and a network management device 7.

The transmitter 9 and the de-multiplexer 8 are arranged within a first client side network, and the receiver 6 and the multiplexer 5 are arranged within a second client side network. The one set of transmitting side transmission devices 1a and 1b, the one set of receiving side transmission devices 2a and 2b, and the network management device 7 are arranged within a backbone network. The first client side network and the second client side network are interconnected via the backbone network.

The one set of transmitting side transmission devices 1a and 1b is an example of one set of first transmission devices, and the one set of receiving side transmission devices 2a and 2b is an example of one set of second transmission devices. The transmitting side transmission device 1a is connected to the receiving side transmission device 2a via a transmission line Ra, and the transmitting side transmission device 1b is connected to the receiving side transmission device 2b via a transmission line Rb. The transmitting side transmission device 1a and the receiving side transmission device 2a have a redundant configuration as a “0 system,” and the transmitting side transmission device 1b and the receiving side transmission device 2b have a redundant configuration as a “1 system.”

The network management device 7 is one example of a management device and manages the transmitting side transmission devices 1a and 1b and the receiving side transmission devices 2a and 2b. The network management device 7 selects an operation system and a backup system waiting in preparation for a failure of the operation system, from the 0 system and the 1 system, respectively.

The transmitter 9 transmits a client signal Sc, which is one example of a data signal, to the transmitting side transmission devices 1a and 1b via the de-multiplexer 8. An example of the client signal Sc may include an SDH frame, a SONET frame, an Ethernet frame and the like. The de-multiplexer 8 is, for example, a Y-branch cable with an optical splitter and distributes the client signal Sc to the transmitting side transmission devices 1a and 1b.

The transmitting side transmission devices 1a and 1b map the client signal Sc into an OTU frame Sf and transmits the OUT frame Sf, for example, according to the transmission scheme specified in the ITU-T Recommendation G.709. The OTU frame Sf, which is one example of a frame, is transmitted through the transmission lines Ra and Rb and received by the receiving side transmission devices 2a and 2b.

The receiving side transmission devices 2a and 2b regenerate the client signal Sc from the OTU frame Sf and transmit the regenerated client signal Sc to the receiver 6 via the multiplexer 5. The multiplexer 5 is, for example, a Y-branch cable with an optical coupler and guides the client signal Sc from the receiving side transmission devices 2a and 2b to the receiver 6. However, only the client signal Sc from one side, which acts as the operation system by the control of the network management device 7, of the receiving side transmission devices 2a and 2b of the 0 and 1 systems, is transmitted to the receiver 6.

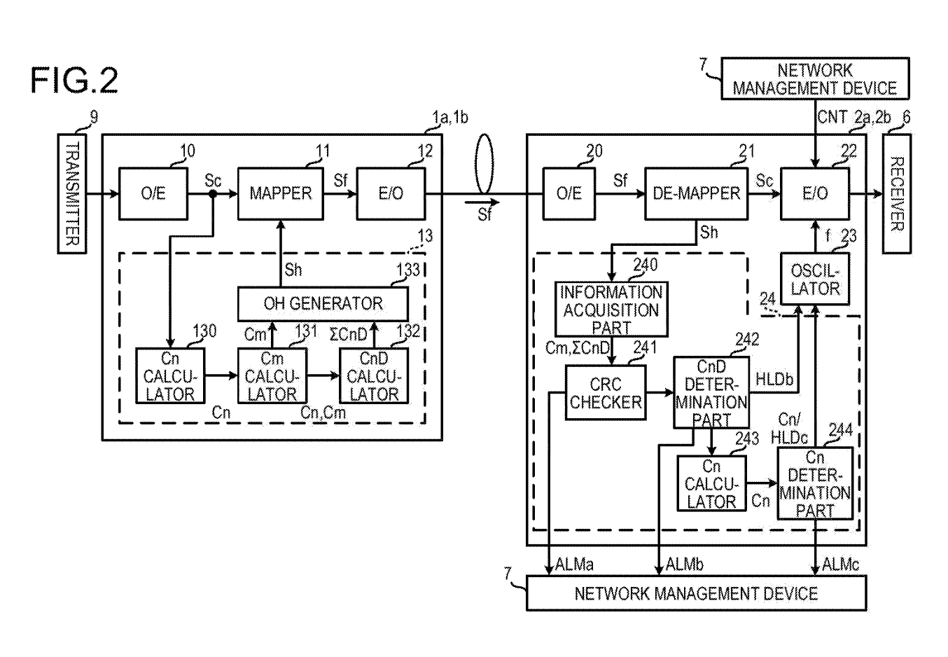

FIG. 2 is a block diagram illustrating the transmission devices 1a, 1b, 2a, and 2b according to the first embodiment. Each of the transmitting side transmission devices 1a and 1b includes an optical/electrical (O/E) converter 10, a mapper 11, an electrical/optical (E/O) converter 12, and a processor 13.

The O/E converter 10 receives the client signal Sc from the transmitter 9, converts the client signal Sc from an optical signal into an electrical signal, and outputs the electrical signal to the mapper 11. The O/E converter 10 includes, for example, a photo diode (PD). The mapper 11 maps (accommodates) an overhead Sh and the client signal Sc into the OTU frame Sf. The overhead Sh is one example of control information accompanying the OTU frame Sf and is generated by the processor 13.

The processor 13 is, for example, configured with a digital signal processor (DSP) that is a kind of a hardware processor and includes a Cn calculator 130, a Cm calculator 131, a CnD calculator 132, and an overhead (OH) generator 133. The Cn calculator 130, the Cm calculator 131, and the CnD calculator 132 are one example of a first acquisition part and acquire a numerical value related to the frequency of the client signal Sc from the client signal Sc.

More specifically, the Cn calculator 130 calculates a numerical value Cn which corresponds to the number of bytes of a payload of the client signal Sc. For example, based on a clock signal synchronized with the client signal Sc, the Cn calculator 130 counts the number of bytes of the payload of the client signal Sc.

Cn=f_{client}/n×Tₛₑᵣᵥₑᵣ (1)

Assuming that a bit rate of the client signal Sc is f_{client}, and a period of the client signal Sc is Tₛₑᵣᵥₑᵣ, the numerical value Cn is represented by the above formula (1). Here, n represents a timing granularity in a generic mapping procedure (GMP) for mapping the client signal Sc into the OTU frame Sf. In this example, n=8 bits.

Cn(t)=floor(f_{client}/n×Tₛₑᵣᵥₑᵣ) (2)

Cn(t)=ceiling(f_{client}/n×Tₛₑᵣᵥₑᵣ)=1+floor(f_{client}/n×Tₛₑᵣᵥₑᵣ) (3)

In a case where the numerical value Cn is not an integer, it is transformed into an integer value Cn(t) to be processed, according to the above formula (2) or (3). Here, the floor function outputs the maximum integer which is equal to or smaller than an input value (a numerical value in parentheses), and the ceiling function outputs the maximum integer which is equal to or larger than an input value. The calculated numerical value Cn is output to the Cm calculator 131.

The Cm calculator 131 calculates a numerical value Cm representing a data entity in the unit of M (bytes) in a process of mapping the client signal Sc to the OTU frame Sf.

Cm=n×Cn×/m=f_{client}/fₛₑᵣᵥₑᵣ×Bₛₑᵣᵥₑᵣ/m=f_{client}/fₛₑᵣᵥₑᵣ×Bₛₑᵣᵥₑᵣ/(8×M) (4)

The numerical value Cm is calculated from the numerical value Cn according to the above formula (4). Here, fₛₑᵣᵥₑᵣ is a bit rate of an OPUk payload (k=0, 1, 2, 3, 4, 2e) within the OTU frame and is Bₛₑᵣᵥₑᵣ=fₛₑᵣᵥₑᵣ×Tₛₑᵣᵥₑᵣ. The calculated numerical value Cm is transformed into an integer value according to a formula such as, for example, the above formula (2) or (3). The integer value Cm(n) is output to the overhead (OH) generator 133 and the CnD calculator 132. The integer value Cn(t) of the numerical value Cn is also output to the CnD calculator 132.

The CnD calculator 132 calculates an integer value CnD(t) of a numerical value CnD remaining when a data entity in the unit of M (bytes) is mapped into a payload in a process of mapping the client signal Sc into the OTU frame Sf.

CnD(t)=Cn(t)−8×M/n×Cm(t) (5)

A numerical value CnD(t) is calculated according to the above formula (5). In addition, the CnD calculator 132 calculates an accumulated value ΣCnD(t) by accumulating numerical values CnD(t) of OTU frames Sf. The calculated accumulated value ΣCnD(t) is output to the OH generator 133. The above-described numerical values Cn(t) and Cm(t) and accumulated value ΣCnD(t) are one example of a numerical value related to the frequency of the client signal Sc.

The OH generator 133 calculates CRC values of the numerical value Cm(t) and the accumulated value ΣCnD(t). The CRC values are one example of an error detecting code for detecting an error of the numerical value Cm(t) and the accumulated value ΣCnD(t). The OH generator 133 generates an overhead Sh including the numerical value Cm(t) and the accumulated value ΣCnD(t), and their CRC values and outputs the overhead Sh to the mapper 11. Meanwhile, the overhead Sh is one example of control information mapped into the OTU frame Sf.

The mapper 11 maps (multiplexes) the overhead Sh generated by the OH generator 133 and the client signal Sc into the OTU frame Sf. A configuration of the OTU frame Sf will be described below.

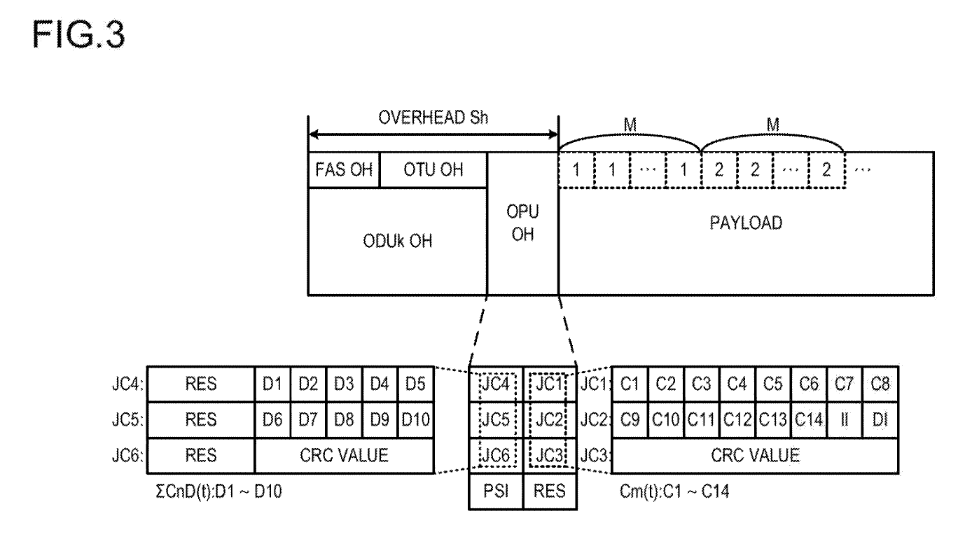

FIG. 3 is a block diagram illustrating the OTU frame Sf according to the first embodiment. The OTU frame Sf includes an overhead Sh and a payload. The overhead Sh includes a frame alignment signal (FAS) overhead, an OTU overhead, an optical channel data unit (ODU)k overhead, and an optical channel payload unit (OPU) overhead.

The FAS overhead has unique pattern data indicating the beginning of the OTU frame Sf and is used for a frame synchronizing process in the receiving side transmission devices 2a and 2b. The OTU overhead and the ODUk overhead have a variety of parameters related to, for example, a monitoring function.

The OPU overhead includes a payload structure identifier (PSI), justification controls (JCs) 1 to 6, and a reserved for future international standardization (RES). Each of JC1 to JC6 has a 1 byte area.

A bit string of 14 bits C1 to C14 indicating the numerical value Cm(t) is stored in JC1 and JC2. An increment indicator (II) indicating the increase of the numerical Cm(t) and a decrement indicator (DI) indicating the decrease of the numerical Cm(t) are stored in the remaining areas of JC2. A 8-bit CRC value calculated by CRC-8 from the numerical value Cm(t) is stored in JC3.

A bit string of 10 bits D1 to D10 indicating the accumulated value ΣCnD(t) is stored in JC4 and JC5. The remaining areas of JC4 and JC5 except for the bit string D1 to D10 are treated as RES. A 5-bit CRC value calculated by CRC-5 from the accumulated value ΣCnD(t) is stored in JC6. The remaining areas of JC6 are treated as RES.

The client signal Sc is mapped in the payload. The client signal Sc is mapped into the payload for each of 1 (byte)×M blocks assigned with common numbers (1, 2, . . . ) according to GMP. Accordingly, based on the numerical value Cm(t) and the accumulated value ΣCnD(t), the receiving side transmission devices 2a and 2b de-map the client signal Sc from the payload.

In the meantime, the OTU frame Sf may be configured to map an ODU frame of a low order (LO) with a low transmission rate, as the client signal Sc, into an ODU frame of a high order (HO) with a high transmission rate. An ODU frame has a plurality of types of transmission rates. For example, “ODU0” of 1.25 Gbps, “ODU1” of 5 Gbps, “ODU2” of 10 Gbps, “ODU3” of 40 Gbps, and “ODU4” of 100 Gbps are specified in the ITU-T Recommendation G.709.

Referring to FIG. 2 again, the mapper 11 outputs the OTU frame Sf to the E/O converter 12. The E/O converter 12 converts the OTU frame Sf from an electrical signal into an optical signal which is then output to the transmission lines Ra and Rb. The E/O converter 12 includes, for example, a laser diode (LD).

Each of the receiving side transmission devices 2a and 2b includes an optical/electrical (O/E) converter 20, a de-mapper 21, an electrical/optical (E/O) converter 22, an oscillator 23, and a processor 24.

The O/E converter 20, which is one example of a receiver, receives the OTU frame Sf from the transmitting side transmission devices 1a and 1b and converts the OTU frame Sf from an optical signal into an electrical signal which is then output to the de-mapper 21. The O/E converter 20 includes, for example, a PD. The de-mapper 21 separates the overhead Sh and the client signal Sc from the received OTU frame Sf. The separated client signal Sc is output to the E/O converter 22, and the separated overhead Sh is output to the processor 24.

The E/O converter 22 converts the OTU frame Sf from an electrical signal into an optical signal which is then transmitted to the receiver 6. The E/O converter 22 includes, for example, a LD.

The E/O converter 22 is turned on/off in response to a control signal CNT input from the network management device 7. The network management device 7 outputs a control signal CNT to control the E/O converter 22 to be turned on (active) for the receiving side transmission devices 2a and 2b of the operation system and outputs a control signal CNT to control the E/O converter 22 to be turned off (inactive) for the receiving side transmission devices 2a and 2b of the backup system.

In addition, the E/O converter 22 performs a photoelectric conversion of the client signal Sc in synchronization with a frequency signal f input from the oscillator 23. The oscillator 23 is, for example, a voltage-controlled crystal oscillator (VCXO). The oscillator 23 generates the frequency signal f based on the numerical value Cn sent from the processor 24 and outputs the frequency signal f to the E/O converter 22.

The numerical value Cn is calculated from the numerical value Cm(t) and the accumulated value ΣCnD(t) acquired from the overhead Sh in the processor 24, as will be described later. In this way, the oscillator 23 and the E/O converter 22 are one example of a regenerator and regenerate the client signal Sc with a frequency based on the numerical value Cn(t).

The processor 24 is configured with, for example, a DSP that is a kind of a hardware processor and includes an information acquisition part 240, a CRC checker 241, a CnD determination part 242, a Cn calculator 243, and a Cn determination part 244. The information acquisition part 240 is one example of a second acquisition part and acquires the numerical value Cm(t), the accumulated value ΣCnD(t), and the CRC value from the overhead Sh. The numerical value Cm(t), the accumulated value ΣCnD(t), and the CRC value are output to the CRC checker 241.

The CRC checker 241 calculates a CRC value of each of the numerical value Cm(t) and the accumulated value ΣCnD(t), and compares the CRC value with a CRC value acquired from each of JC3 and JC6 of the overhead Sh. As a result of the comparison, when the CRC value of at least one of the numerical value Cm(t) and the accumulated value ΣCnD(t) is not equal to the acquired CRC value, the CRC checker 241 determines that an error has occurred in at least one of the numerical value Cm(t) and the accumulated value ΣCnD(t), and outputs an alarm ALMa to the network management device 7. When the alarm ALMa is input, the network management device 7 switches the operation system between the 0 system and the 1 system.

When each CRC value of the numerical value Cm(t) and the accumulated value ΣCnD(t) is equal to the acquired CRC value, the CRC checker 241 outputs the numerical value Cm(t) and the accumulated value ΣCnD(t) to the CnD determination part 242. The CnD determination part 242, which is one example of an output part, calculates a variation of the accumulated value ΣCnD(t) for each OTU frame Sf and outputs an alarm ALMb to the network management device 7 in response to the variation.

More specifically, the CnD determination part 242 calculates a difference between an accumulated value ΣCnD(t) of a newly received OTU frame Sf and an accumulated value ΣCnD(t) of the previously received OTU frame Sf, i.e., the numerical value CnD(t). The CnD determination part 242 compares an absolute value of the numerical value CnD(t) with a predetermined value 8×M/n−1.

According to the above formula (5), a range of the numerical value CnD(t) is between 1-8×M/n and 8×M/n−1. Therefore, when |CnD(t)|>8×M/n−1, the CnD determination part 242 determines that an error has occurred in the accumulated value ΣCnD(t). Meanwhile, in this example, since n=8, when |CnD(t)|>M−1, the CnD determination part 242 determines that an error has occurred in the accumulated value ΣCnD(t).

The CnD determination part 242 counts the number of times Nb by which |CnD(t)| exceeds a predetermined value M−1, and outputs the alarm ALMb to the network management device 7 when the number of times Nb reaches a predetermined value Nb_max. Therefore, an output of the alarm ALMb due to a minor error is inhibited. When the alarm ALMb is input, the network management device 7 switches an active system between the 0 system and the 1 system.

In addition, when |CnD(t)| exceeds the predetermined value M−1, and the number of times Nb is smaller than the predetermined value Nb_max, the CnD determination part 242 outputs an instruction signal HLDb to the oscillator 23. Accordingly, the CnD determination part 242 instructs to regenerate the client signal Sc with a frequency based on the numerical value Cn(t) when |CnD(t)| is equal to or smaller than the predetermined value M−1.

Upon receiving the instruction signal HLDb, the oscillator 23 fixes the frequency of the frequency signal f. At this time, without changing the frequency based on the numerical value Cn(t), the oscillator 23 maintains the previous frequency. Since the numerical value Cn(t) is calculated from the accumulated value ΣCnD(t), an error is prevented from occurring in the client signal Sc due to a frequency maintained based on an incorrect numerical value Cn(t). In addition, the numerical value Cm(t) and the accumulated value ΣCnD(t) are output to the Cn calculator 243.

Based on the above formula (5), the Cn calculator 243 calculates the numerical value Cn(t) from the numerical value Cm(t) and the accumulated value ΣCnD(t). In other words, the Cn calculator 243 is another example of the second acquisition part and acquires the numerical value Cn(t) from the overhead Sh. The acquired numerical value Cn(t) is output to the Cn determination part 244.

The Cn determination part 244 is another example of the output part and outputs an alarm ALMc to the network management device 7 in response to a variation of the numerical value Cn(t) for each OTU frame Sf. More specifically, the Cn determination part 244 calculates a difference ΔCn(t) between a numerical value Cn(t) of a newly received OTU frame Sf and a numerical value Cn(t) of the previously received OTU frame Sf. The CnD determination part 242 compares an absolute value of the difference ΔCn(t) with 1.

According to the above formulas (2) and (3), the difference ΔCn(t) is equal to or smaller than 1. Therefore, when |ΔCn(t)|>1, the Cn determination part 244 determines that an error has occurred in the numerical value Cn(t) or the numerical value Cm(t).

The Cn determination part 244 counts the number of times Nc by which |ΔCn(t)| exceeds 1, and outputs the alarm ALMc to the network management device 7 when the number of times Nc reaches a predetermined value Nc_max. Therefore, an output of the alarm ALMc due to a minor error is inhibited. When the alarm ALMc is input, the network management device 7 switches the operation system between the 0 system and the 1 system.

In addition, when |ΔCn(t)| exceeds 1, and the number of times Nc is smaller than the predetermined value Nc_max, the Cn determination part 244 outputs an instruction signal HLDc to the oscillator 23. Accordingly, the Cn determination part 244 instructs to regenerate the client signal Sc with a frequency based on the accumulated value ΣCnD when |ΔCn(t)| is equal to or smaller than 1. Accordingly, in this case as well, like the CnD determination part 242, an error is prevented from occurring in the client signal Sc due to a frequency based on an incorrect numerical value Cn(t).

When |ΔCn(t)| is equal to or smaller than 1, and the number of times Nc is smaller than the predetermined value Nc_max, the Cn determination part 244 outputs the numerical value Cn(t) to the oscillator 23. Accordingly, the oscillator 23 generates a frequency signal f based on the numerical value Cn(t) and outputs the frequency signal f to the E/O converter 22. Meanwhile, although it is illustrated in this example that the Cn determination part 244 outputs the alarm ALMc in response to the variation of the numerical value Cn(t), the Cn determination part 244 may detect a variation of the numerical value Cm(t) instead of or along with the numerical value Cn(t) and output the alarm ALMc in response to the variation.

In this way, the CnD determination part 242 and the Cn determination part 244 output the alarms ALMb and ALMc in response to the variations of the numerical values Cn(t) and Cm(t) and the accumulated value ΣCnD(t) for each OTU frame Sf. Therefore, even when the CRC checker 241 may not detect an error of at least one of the numerical value Cn(t) and the accumulated value ΣCnD(t), the CnD determination part 242 and the Cn determination part 244 may output the error as the alarms ALMb and ALMc.

Accordingly, the network management device 7 may restore the error immediately by switching the operation system in response to the alarms ALMb and ALMc. Next, a process of outputting an alarm in the receiving side transmission devices 2a and 2b will be described.

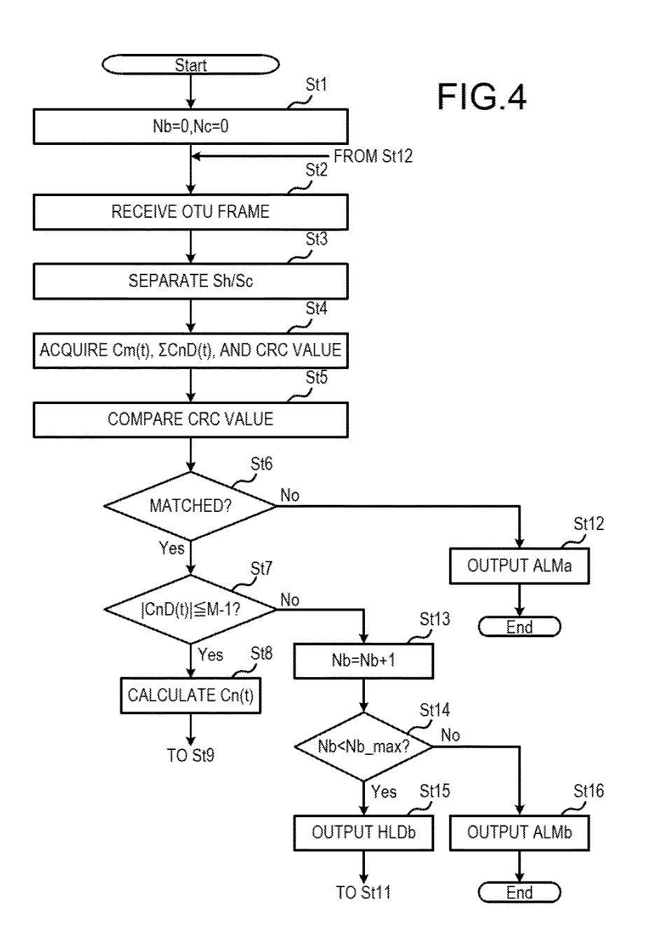

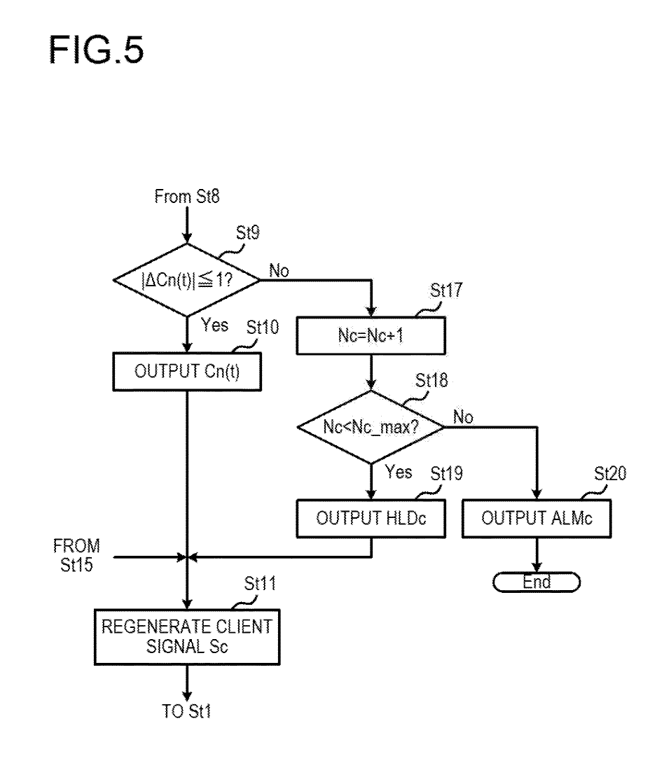

FIGS. 4 and 5 are flow charts illustrating a process of outputting an alarm according to the first embodiment. First, FIG. 4 will be referred to.

When the receiving side transmission devices 2a and 2b are started up, first, the CnD determination part 242 sets Nb to 0, and the Cn determination part 244 sets Nc to 0 (Operation St1). As described above, Nb is the number of times by which |CnD(t)| exceeds the predetermined value M−1, and Nc is the number of times by which |ΔCn(t)| exceeds 1.

Next, the O/E converter 20 receives an OTU frame Sf (Operation St2). Next, the de-mapper 21 separates an overhead Sh and a client signal Sc from the OTU frame Sf (Operation St3). Next, the information acquisition part 240 acquires a numerical value Cm(t) and an accumulated value ΣCnD(t) and their CRC values from the overhead Sh (Operation St4).

Next, the CRC checker 241 calculates a CRC value from the numerical value Cm(t) and compares the CRC value with the acquired CRC value while calculating a CRC value from the accumulated value ΣCnD(t) and comparing the CRC value with the acquired CRC value (Operation St5). That is, the CRC checker 241 performs a CRC check for the numerical value Cm(t) and the accumulated value ΣCnD(t).

When it is checked that the CRC value of at least one of the numerical value Cm(t) and the accumulated value ΣCnD(t) is not equal to the acquired CRC value (No in Operation St6), the CRC checker 241 outputs an alarm ALMa to the network management device 7 (Operation St12). When it is checked that each CRC value of the numerical value Cm(t) and the accumulated value ΣCnD(t) is equal to the acquired CRC value (Yes in Operation St6), the CnD determination part 242 calculates |CnD(t)| from a difference between an accumulated value ΣCnD(t) of the received OTU frame Sf and an accumulated value ΣCnD(t) of the previously received OTU frame Sf and compares the |CnD(t)| with a predetermined value M−1 (Operation St7). When the first OTU frame Sf is received, since no previously received OTU frame Sf exists, the CnD determination part 242 may set the |CnD(t)| to 0 temporarily.

As a result of the comparison, when it is determined that |CnD(t)|>M−1 (No in Operation St7), the CnD determination part 242 adds 1 to the number of times Nb (Operation St13). Next, the CnD determination part 242 compares the number of times Nb with the upper limit Nb_max (Operation St14). As a result of the comparison, when it is determined that Nb≧Ab_max (No in Operation St14), the CnD determination part 242 outputs an alarm ALMb to the network management device 7 (Operation St16). That is, when the number of times Nb reaches the upper limit Nb_max, the alarm ALMb is output.

As a result of the comparison, when it is determined that Nb<Nb_max (Yes in Operation St14), the CnD determination part 242 outputs an instruction signal HLDb to the oscillator 23 (Operation St15). Accordingly, the oscillator 23 maintains the current frequency without changing the frequency of the frequency signal f. Thereafter, a step of Operation St11 to be described later is performed.

In the meantime, when it is determined that |CnD(t)|≦M−1 (Yes in Operation St7), the Cn calculator 243 calculates a numerical Cn(t) from the numerical value Cm(t) and the accumulated value ΣCnD(t) (Operation St8).

Next, descriptions will be made with reference to FIG. 5. The Cn determination 244 calculates |ΔCn(t)| from a difference between the calculated numerical Cn(t) and a numerical Cn(t) of the previously received OTU frame Sf and compares the |ΔCn(t)| with 1 (Operation St9). When the first OTU frame Sf is received, since no previously received OTU frame Sf exists, the Cn determination part 244 may set the |ΔCn(t)| to 0 temporarily.

As a result of the comparison, when it is determined that |ΔCn(t)|>1 (No in Operation St9), the Cn determination 244 adds 1 to the number of times Nc (Operation St17). Next, the Cn determination 244 compares the number of times Nc with the upper limit Nc_max (Operation St18). As a result of the comparison, when it is determined that Nc≧Nc_max (No in Operation St18), the Cn determination part 244 outputs an alarm ALMc to the network management device 7 (Operation St20). That is, when the number of times Nc reaches the upper limit Nc_max, the alarm ALMc is output.

As a result of the comparison, when it is determined that Nc<Nc_max (Yes in Operation St18), the Cn determination part 244 outputs an instruction signal HLDc to the oscillator 23 (Operation St19). Accordingly, the oscillator 23 maintains the current frequency without changing the frequency of the frequency signal f. Thereafter, the step of Operation St11 to be described later is performed.

Meanwhile, when it is determined that |ΔCn(t)|≦1 (Yes in Operation St9), the Cn determination 244 outputs the numerical value Cn(t) to the oscillator 23 (Operation SUM. Next, when the oscillator 23 outputs the frequency signal f to the E/O converter 22, the client signal Sc is regenerated (Operation St11). In this way, the process of outputting an alarm is performed.

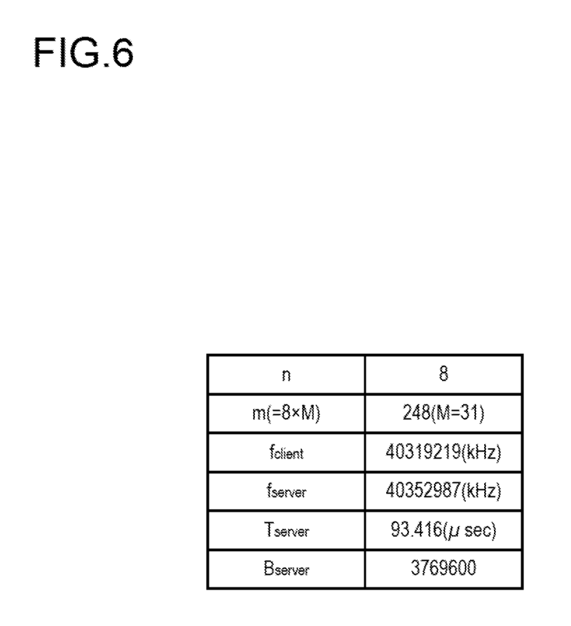

Next, an example of numerical values in a case where the alarms ALMb and ALMc are output will be described. FIG. 6 illustrates parameters in this example. In this example, with the presumption that LO-ODU3 as a client signal Sc is mapped into a frame of HO-ODU4, m=248, M=31, f_{client}=40319219 kHz, fₛₑᵣᵥₑᵣ=40352987 kHz, Tserver=93.416 μsec, and Bₛₑᵣᵥₑᵣ=3769600. Accordingly, the numerical value Cm in this example is 15187.2804 from the above formula (4).

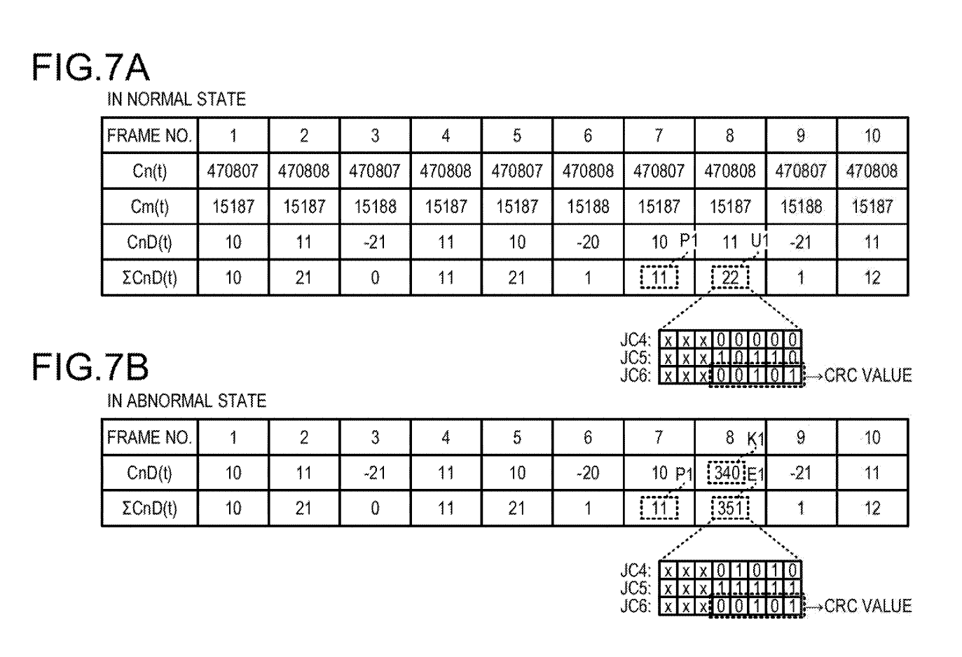

FIG. 7A illustrates one example of numerical values Cn(t), Cm(t), and CnD(t) and an accumulated value ΣCnD(t) in a normal state. FIG. 7A illustrates numerical values Cn(t), Cm(t), and CnD(t) and an accumulated value ΣCnD(t) of an OTU frame Sf of frame numbers 1 to 10 according to the time series. Meanwhile, the CnD(t) is a difference between a current accumulated value ΣCnD(t) of the OTU frame Sf and a previous accumulated value ΣCnD(t) of the OTU frame Sf.

FIG. 7B illustrates one example of an accumulated value ΣCnD(t) in an abnormal state. In FIG. 7B, an error occurs in an accumulated value ΣCnD(t) (=351) denoted by a reference numeral E1.

An accumulated value ΣCnD(t) of the frame number 7 in a normal state and an abnormal state is 11 as denoted by a reference numeral P1, and an accumulated value ΣCnD(t) of the frame number 8 in a normal state is 22 as denoted by a reference numeral U1. At this time, a bit string (binary number) “0000010110” equivalent to “22” in decimal is stored in JC4 and JC5 within an overhead Sh, and its CRC value “00101” is stored in JC6. In the meantime, “x” indicates an unused RES area.

In contrast, in an abnormal state, an accumulated value ΣCnD(t) of a frame is 351 as denoted by a reference numeral E1. At this time, a bit string (binary number) “0101011111” equivalent to “351” in decimal is stored in JC4 and JC5 within the overhead Sh, and its CRC value “00101” is stored in JC6. That is, even in an abnormal state, the same CRC value as in a normal state is stored.

Therefore, the CRC checker 241 may not detect the accumulated value ΣCnD(t) (=351) of an error denoted by the reference numeral E1 based on the CRC value.

However, the CnD determination part 242 calculates a difference CnD(t) between the current accumulated value ΣCnD(t) of the OTU frame Sf and the previous accumulated value ΣCnD(t) of the OTU frame Sf, and detects an error when CnD(t)>M−1=30. Accordingly, as denoted by a reference numeral K1, since CnD(t) of the frame number 8 in an abnormal state is 340>30, an error is detected. Accordingly, the CnD determination part 242 may detect an error of an accumulated value ΣCnD(t) which may not be detected by the CRC checker 241.

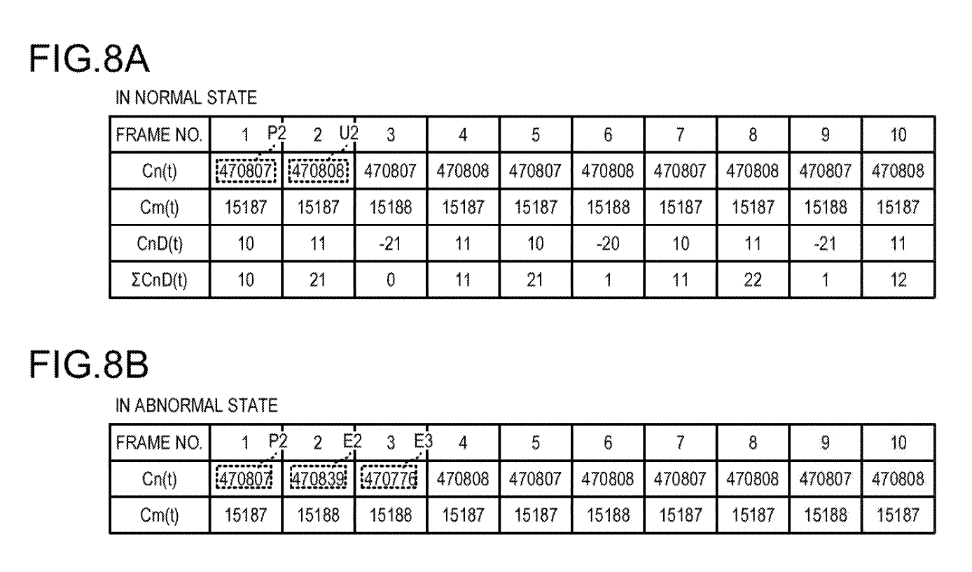

FIG. 8A illustrates one example of numerical values Cn(t), Cm(t), and CnD(t), and an accumulated value ΣCnD(t) in a normal state. FIG. 8B illustrates one example of numerical values Cn(t) and Cm(t) in an abnormal state. The numerical values in FIG. 8A are the same as those in FIG. 7A. In FIG. 8B, an error occurs in a numerical values Cn(t) (=470839) denoted by a reference numeral E2 and a numerical values Cn(t) (=470776) denoted by a reference numeral E3.

A numerical value Cn(t) of the frame number 1 in a normal state and an abnormal state is 470807 as denoted by a reference numeral P2, and a numerical value Cn(t) of the frame number 2 in a normal state is 470808 as denoted by a reference numeral U2. At this time, the Cn determination part 244 calculates |ΔCn(t)|=470808−470807=1 and accordingly detects no error since it is determined that |ΔCn(t)|≦1.

In contrast, in an abnormal state, a numerical value Cn(t) of the frame number 2 is 470839 as denoted by the reference numeral E2. At this time, the Cn determination part 244 calculates |ΔCn(t)|=|470839−470807|=32 and accordingly detects an error since it is determined that |ΔCn(t)|>1. In addition, a numerical value Cn(t) of the frame number 3 is 470776 as denoted by the reference numeral E3. At this time, the Cn determination part 244 calculates |ΔCn(t)|=|470776−470839|=63 and accordingly detects an error since it is determined that |ΔCn(t)|>1.

In this way, the Cn determination part 244 may detect an error of a numerical value Cn(t) from a difference between the current numerical value Cn(t) of the OTU frame Sf and the previous numerical value Cn(t) of the OTU frame Sf. Alternatively, the Cn determination part 244 may detect an error from a difference between numerical values Cm(t) instead of the numerical values Cn(t). Next, an operation of the network management device 7 will be described.

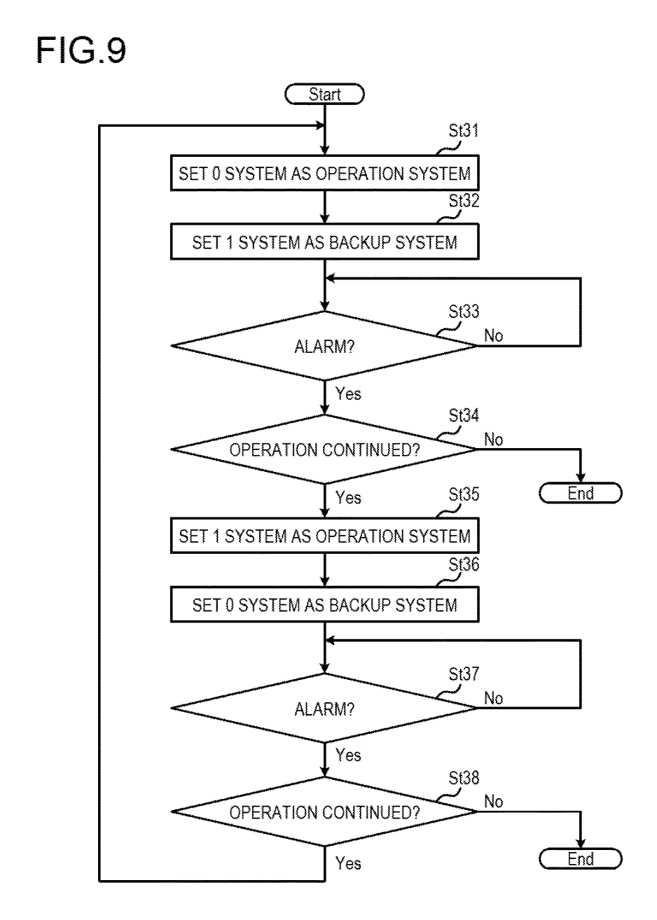

FIG. 9 is a flow chart illustrating one example of a system switching process of the network management device 7. First, the network management device 7 sets the transmitting side transmission device 1a and the receiving side transmission device 2a of the 0 system as an operation system (Operation St31). More specifically, the network management device 7 transmits a control signal CNT to turn on the E/O converter 22 to the receiving side transmission device 2a.

Next, the network management device 7 sets the transmitting side transmission device 1b and the receiving side transmission device 2b of the 1 system as a backup system (Operation St32). More specifically, the network management device 7 transmits a control signal CNT to turn off the E/O converter 22 to the receiving side transmission device 2b.

Next, the network management device 7 determines whether or not alarms ALMa to ALMc are input (Operation St33). When it is determined that the alarms ALMa to ALMc are not input (No in Operation St33), the network management device 7 performs the determining operation of Operation St33 again.

Next, for example, based on a manipulation by a manager, the network management device 7 determines whether to continue the operation of the transmission system (Operation St34). When it is determined that the operation of the transmission system is not continued (No in Operation St34), the network management device 7 ends the process.

When it is determined that the operation of the transmission system is continued (Yes in Operation St34), the network management device 7 sets the transmitting side transmission device 1b and the receiving side transmission device 2b of the 1 system as the operation system (Operation St35). Next, the network management device 7 sets the transmitting side transmission device 1a and the receiving side transmission device 2a of the 0 system as the backup system (Operation St36).

Next, the network management device 7 determines whether or not alarms ALMa to ALMc are input (Operation St37). When it is determined that the alarms ALMa to ALMc are not input (No in Operation St37), the network management device 7 performs the determining operation of Operation St37 again.

Next, for example, based on a manipulation by the manager, the network management device 7 determines whether to continue the operation of the transmission system (Operation St38). When it is determined that the operation of the transmission system is not continued (No in Operation St38), the network management device 7 ends the process.

When it is determined that the operation of the transmission system is continued (Yes in Operation St38), the network management device 7 performs the process again starting at Operation St31. In this way, the system switching process of the network management device 7 is performed.

Thus, when the alarms ALMa to ALMc are input, the network management device 7 switches the transmitting side transmission devices 1a and 1b and the receiving side transmission device 2a and 2b of the operation system to transmit/receive the OTU frame Sf. Accordingly, the network management device 7 may easily restore any error occurring in the numerical values Cn(t) and Cm(t) or the accumulated value ΣCnD(t).

As described above, the receiving side transmission device 2a and 2b according to this embodiment includes the O/E converter 20, the de-mapper 21, the E/O converter 22, the oscillator 23 and the processor 24. The processor 24 includes the information acquisition part 240, the CnD determination part 242, the Cn calculator 243, and the Cn determination part 244.

The O/E converter 20 receives the OTU frame Sf into which the overhead Sh and the client signal Sc are mapped (multiplexed). The de-mapper 21 separates the overhead Sh and the client signal Sc from OTU frame Sf received by the O/E converter 20.

The information acquisition part 240 and the Cn calculator 243 acquire the numerical values Cn(t) and Cm(t) and the accumulated value ΣCnD(t) related to the frequency of the client signal Sc from the overhead Sh separated by de-mapper 21. The E/O converter 22 and the oscillator 23 regenerate the client signal Sc separated by de-mapper 21 with a frequency based on the numerical value Cn(t) acquired by the information acquisition part 240.

The CnD determination part 242 outputs the alarm ALMb in response to a variation of the accumulated value ΣCnD(t) for each OTU frame Sf. The Cn determination part 244 outputs the alarm ALMc in response to a variation of the numerical value Cn(t) for each OTU frame Sf.

With the above-described configuration, the CnD determination part 242 and the Cn determination part 244 output the alarms ALMb and ALMc in response to a variation of the numerical value Cn(t) and the accumulated value ΣCnD(t) for each OTU frame Sf. Therefore, even when an error of at least one of the numerical value Cn(t) and the accumulated value ΣCnD(t) may not be detected by the CRC check, the CnD determination part 242 and the Cn determination part 244 may output the error as the alarms ALMb and ALMc.

Accordingly, the network management device 7 may restore the error immediately by switching the operation system in response to the alarms ALMb and ALMc. As a result, with the receiving side transmission device 2a and 2b according to this embodiment, it is possible to shorten a time taken to restore an error of the client signal Sc due to a frequency deviation.

In addition, the transmission system according to this embodiment includes one set of redundant-configured transmitting side transmission devices 1a and 1b, and one set of redundant-configured receiving side transmission devices 2a and 2b which are respectively connected to the one set of redundant-configured transmitting side transmission devices 1a and 1b, and the network management device 7. The network management device 7 manages the one set of transmitting side transmission devices 1a and 1b, and the one set of receiving side transmission devices 2a and 2b.

Each of the transmitting side transmission devices 1a and 1b includes the processor 13, the mapper 11, and the E/O converter 12. The processor 13 includes the Cn calculator 130, the Cm calculator 131, the CnD calculator 132, and the overhead generator 133.

The Cn calculator 130, the Cm calculator 131, and the CnD calculator 132 acquire the numerical values Cn(t) and Cm(t) and the accumulated value ΣCnD(t) related to the frequency of the client signal Sc from the client signal Sc. The overhead generator 133 generates the overhead Sh including the numerical value Cm(t) and the accumulated value ΣCnD(t) acquired by the Cm calculator 131 and the CnD calculator 132.

The mapper 11 maps (multiplexes) the overhead Sh generated by the overhead generator 133 and the client signal Sc into the OTU frame Sf. The E/O converter 12 transmits the OTU frame Sf to the receiving side transmission devices 2a and 2b.

Each of the receiving side transmission devices 2a and 2b includes the O/E converter 20, the de-mapper 21, the E/O converter 22, the oscillator 23, and the processor 24. The processor 24 includes the information acquisition part 240, the CnD determination part 242, the Cn calculator 243, and the Cn determination part 244.

The O/E converter 20 receives the OTU frame Sf into which the overhead Sh and the client signal Sc are mapped. The de-mapper 21 separates the overhead Sh and the client signal Sc from the OTU frame Sf received by the O/E converter 20.

The information acquisition part 240 and the Cn calculator 243 acquire the numerical values Cn(t) and Cm(t) and the accumulated value ΣCnD(t) related to the frequency of the client signal Sc from the overhead Sh separated by the de-mapper 21. The E/O converter 22 and the oscillator 23 regenerate the client signal Sc separated by de-mapper 21 with a frequency based on the numerical value Cn(t) acquired by the information acquisition part 240.

The CnD determination part 242 outputs the alarm ALMb in response to a variation of the accumulated value ΣCnD(t) for each OTU frame Sf. The Cn determination part 244 outputs the alarm ALMc in response to a variation of the numerical value Cn(t) for each OTU frame Sf.

When the alarm ALMb or ALMc is input from the CnD determination part 242 or the Cn determination part 244, the network management device 7 switches a transmitting side transmission device and a receiving side transmission device, which transmit/receive the OTU frame Sf, of the one set of transmitting side transmission devices 1a and 1b and the one set of receiving side transmission devices 2a and 2b.

Since the transmission system according to this embodiment includes the configuration such as, for example, the above-described receiving side transmission devices 2a and 2b, this transmission system exhibits the acting effects as described above.

The transmission method according to this embodiment includes the following operations.
Operation (1): Receiving the OTU frame Sf into which the overhead Sh and the client signal Sc are mapped (multiplexed)
Operation (2): Separating the overhead Sh and the client signal Sc from the received OTU frame Sf
Operation (3): Acquiring the numerical values Cn(t) and Cm(t) and the accumulated value ΣCnD(t) related to the frequency of the client signal Sc from the separated overhead Sh
Operation (4): Reproducing the separated client signal Sc with a frequency based on the acquired numerical value Cn(t)
Operation (5): Outputting the alarms ALMb and ALMc in response to a variation of the numerical value Cn(t) and the accumulated value ΣCnD(t) for each OTU frame Sf

Since the transmission method according to this embodiment includes the configuration such as, for example, the above-described receiving side transmission devices 2a and 2b, this transmission method exhibits the acting effects as described above.

### Second Embodiment

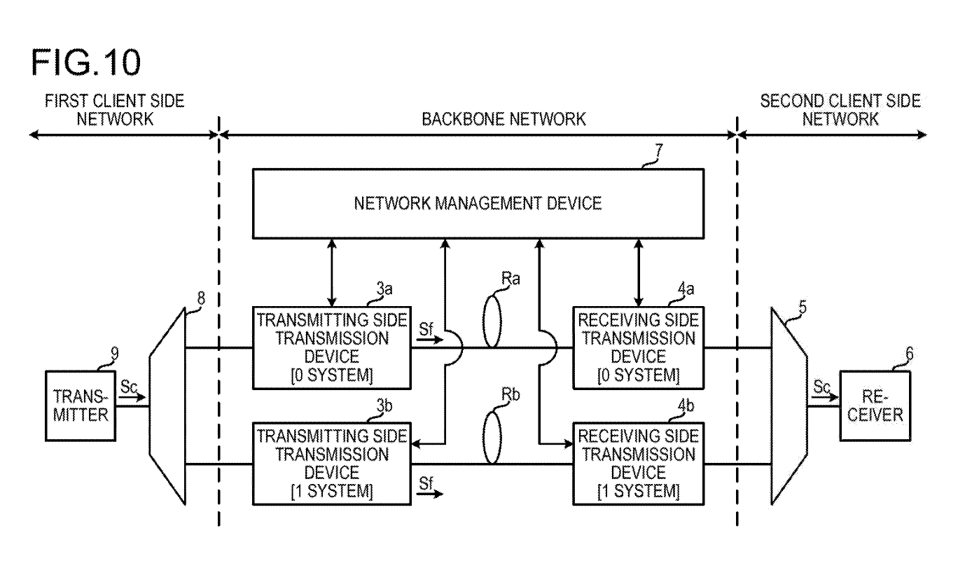

FIG. 10 is a block diagram illustrating a transmission system according to a second embodiment. In FIG. 10, the same elements and operations as those in FIG. 1 will be denoted by the same reference numerals as used in FIG. 1, and explanation thereof will be omitted.

One set of transmitting side transmission devices 3a and 3b is one example of one set of third transmission devices, and one set of receiving side transmission devices 4a and 4b is one example of one set of fourth transmission devices. The transmitting side transmission device 3a is connected to the receiving side transmission device 4a via a transmission line Ra, and the transmitting side transmission device 3b is connected to the receiving side transmission device 4b via a transmission line Rb. The transmitting side transmission device 3a and the receiving side transmission device 4a have a redundant configuration as a “0 system,” and the transmitting side transmission device 3b and the receiving side transmission device 4b have a redundant configuration as a “1 system.”

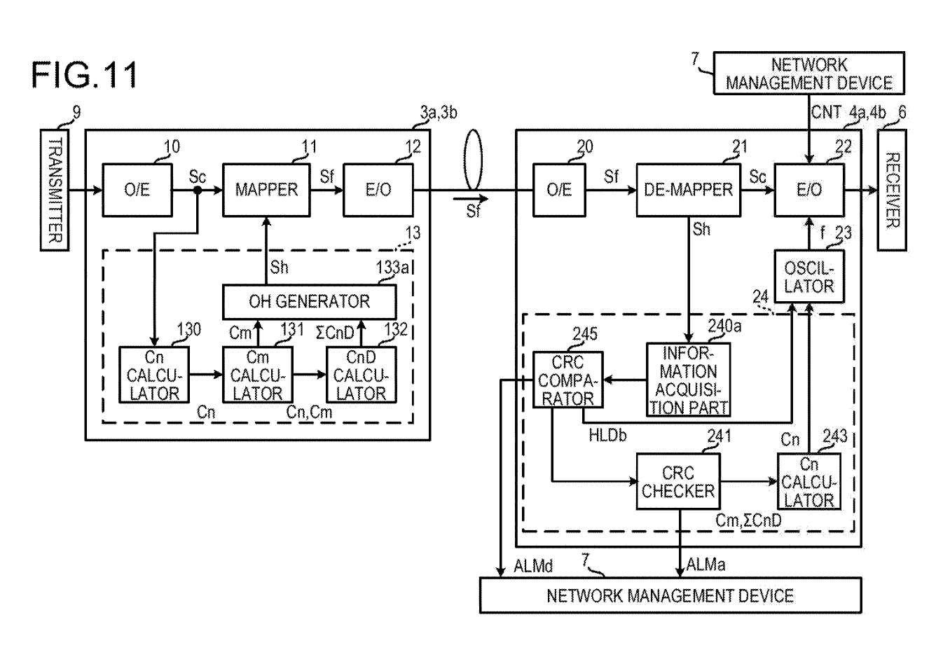

FIG. 11 is a block diagram illustrating the transmission devices 3a, 3b, 4a, and 4b according to the second embodiment. In FIG. 11, the same elements and operations as those in FIG. 2 will be denoted by the same reference numerals as used in FIG. 2, and explanation thereof will be omitted.

Each of the transmitting side transmission devices 3a and 3b includes an optical/electrical (O/E) converter 10, a mapper 11, an electrical/optical (E/O) converter 12, and a processor 13. The processor 13 includes a Cn calculator 130, a Cm calculator 131, a CnD calculator 132, and an overhead (OH) generator 133a. The Cn calculator 130, the Cm calculator 131, and the CnD calculator 132 are one example of a third acquisition part.

The OH generator 133a calculates CRC values of the numerical value Cm(t) and the accumulated value ΣCnD(t). In addition, the OH generator 133a calculates a bit inverted value obtained by bit-inverting each CRC value. When the CRC value of the numerical value Cm(t) is represented by “01101011,” its bit inverted value is represented by a bit string “10010100.” The bit inverted value is one example of an inverted code and is used to detect an error of the CRC value in the receiving side transmission devices 4a and 4b.

The OH generator 133a, which is one example of a generator, generates an overhead Sh including the numerical value Cm(t), the accumulated value ΣCnD(t), and their CRC values, and the bit inverted value and outputs the overhead Sh to the mapper 11. The E/O converter 12 is one example of a transmitter and transmits the OTU frame Sf into which the overhead Sh and the client signal Sc are mapped, to the receiving side transmission devices 4a and 4b.

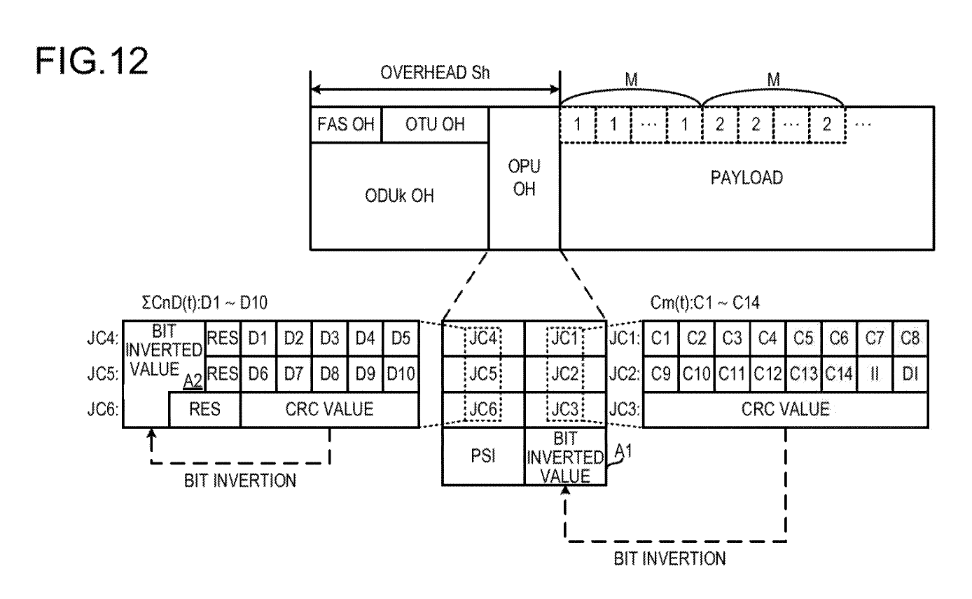

FIG. 12 is a block diagram illustrating the OTU frame Sf according to the second embodiment. In FIG. 12, the same elements and operations as those in FIG. 3 will be denoted by the same reference numerals as used in FIG. 3, and explanation thereof will be omitted.

A bit inverted value of a CRC value of the numerical value Cm(t) (bit string C1 to C14) is stored in a RES area A1 of the OPU overhead. A bit inverted value of a CRC value of the accumulated value ΣCnD(t) (bit string D1 to D10) is stored in a RES area A2 in JC4 to JC6 of the OPU overhead.

Accordingly, the bit inverted values of the CRC values are transmitted to the receiving side transmission devices 4a and 4b.

Referring to FIG. 11 again, each of the receiving side transmission devices 4a and 4b includes an O/E converter 20, a de-mapper 21, an E/O converter 22, an oscillator 23, and a processor 24. The O/E converter 20 is one example of a receiver. The oscillator 23 and the E/O converter 22 are one example of a regenerator.

The processor 24 includes an information acquisition part 240a, a CRC comparator 245, a CRC checker 241, and a Cn calculator 243. The information acquisition part 240a is one example of a fourth acquisition part and acquires the numerical value Cm(t), the accumulated value ΣCnD(t), the CRC value, and the bit inverted value from the overhead Sh. The numerical value Cm(t), the accumulated value ΣCnD(t), the CRC value, and the bit inverted value are output to the CRC comparator 245.

The CRC comparator 245, which is one example of an output part, compares a CRC value and a bit inverted value for each of the numerical value Cm(t) and the accumulated value ΣCnD(t) and outputs an alarm ALMd to the network management device 7 in response to a result of the comparison. More specifically, the CRC comparator 245 compares a value, which is obtained by bit-inverting the CRC value of the numerical value Cm(t), with the bit inverted value and compares a value, which is obtained by bit-inverting the CRC value of the accumulated value ΣCnD(t), with the bit inverted value. Conversely, the CRC comparator 245 may compare the CRC value of the numerical value Cm(t) with a value which is obtained by bit-inverting the bit inverted value and compare the CRC value of the accumulated value ΣCnD(t) with a value which is obtained by bit-inverting the bit inverted value.

As a result of the comparison, when the CRC value and the bit inverted value of at least one of the numerical value Cm(t) and the accumulated value ΣCnD(t) are not equal to each other, the CRC comparator 245 determines that an error occurs in the CRC value. The CRC comparator 245 counts the number of times of inequality Nd and outputs the alarm ALMd to the network management device 7 when the number of times of inequality Nd reaches the predetermined number of times Nd_max. Therefore, an output of the alarm ALMd due to a minor error is inhibited. When the alarm ALMd is input, the network management device 7 switches the operation system between the 0 system and the 1 system.

In addition, as a result of the comparison, when the CRC value and the bit inverted value are not equal to each other, the CRC comparator 245 outputs an instruction signal HLDd to the oscillator 23 when the number of times of inequality Nd is less than the predetermined number of times Nd_max. Accordingly, the CRC comparator 245 instructs to regenerate the client signal Sc with a frequency based on the numerical value Cn(t) when the CRC value and the bit inverted value are equal to each other.

Upon receiving the instruction signal HLDd, the oscillator 23 fixes the frequency of the frequency signal f. Since the numerical value Cn(t) is calculated from the numerical value Cm(t) and the accumulated value ΣCnD(t), an error is prevented from occurring in the client signal Sc due to a frequency maintained based on an incorrect numerical value Cn(t). Meanwhile, when the CRC value and the bit inverted value are equal to each other, the numerical value Cm(t), the accumulated value ΣCnD(t), and their CRC values are output to the CRC checker 241.

As described above, in this embodiment, the OH generator 133a of each of the transmitting side transmission devices 3a and 3b generates the overhead Sh including the numerical value Cm(t), the accumulated value ΣCnD(t), their CRC values, and the bit inverted value. The E/O converter 12 transmits the OTU frame Sf into which the overhead Sh and the client signal Sc are mapped, to the receiving side transmission devices 4a and 4b.

Therefore, the CRC comparator 245 of each of the receiving side transmission devices 4a and 4b may detect an error of the CRC value by comparing the CRC value and the bit inverted value acquired from the overhead Sh of the received OTU frame Sf, and may output the alarm ALMd. Accordingly, the network management device 7 may restore the error immediately by performing system switching in response to the alarm ALMd.

The CRC value error detection is particularly useful, for example, when the numerical value Cm(t) or the accumulated value ΣCnD(t) is zero (0). In this case, since the bit string of the CRC value is all “0,” if the CRC value error detection is not performed, it is impossible to determine whether the bit string of the numerical value Cm(t) or the accumulated value ΣCnD(t) and the bit string of its CRC value are “0” in real or by an error, which will be described below by way of an example.

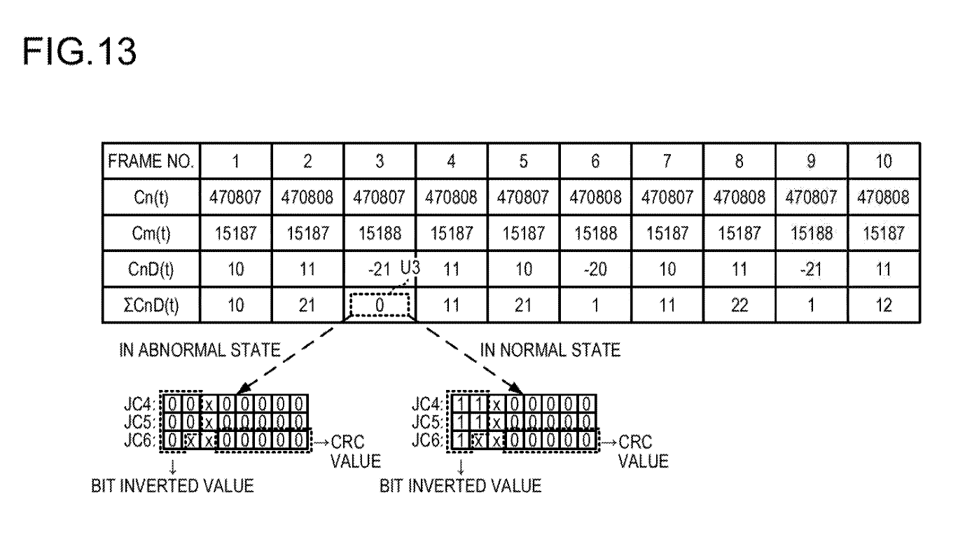

FIG. 13 illustrates one example of numerical values Cn(t), Cm(t), and CnD(t), and an accumulated value ΣCnD(t). In this example, an accumulated value ΣCnD(t) of the frame number 3 is 0 as denoted by a reference numeral U3. At this time, a bit string (binary number) “0000000000” equivalent to “0” in decimal is stored in JC4 and JC5 within an overhead Sh, and its CRC value “00000” is stored in JC6. “x” indicates an unused RES area.

In this example, since the accumulated value ΣCnD(t) is 0, and its CRC value is also 0, it is impossible to determine whether they are “0” in real or by an error. However, the CRC comparator 245 may determine the normality of the CRC value by comparing the CRC value with a bit inverted value.

The bit inverted value is stored in the upper bits of JC4 to JC6. When the bit inverted value is a bit string “11111,” since the bit inverted value matches a bit string “1111” obtained by bit-inverting the CRC value, the CRC value is determined as normal (see “in a normal state”). Meanwhile, when the bit inverted value is a bit string “00000,” since the bit inverted value does not match the bit string “1111” obtained by bit-inverting the CRC value, the CRC value is determined as abnormal (see “in an abnormal state”).

In this way, the CRC comparator 245 may easily detect an error of the CRC value by comparing the CRC value with its bit inverted value. Next, a process of outputting an alarm according to this embodiment will be described below.

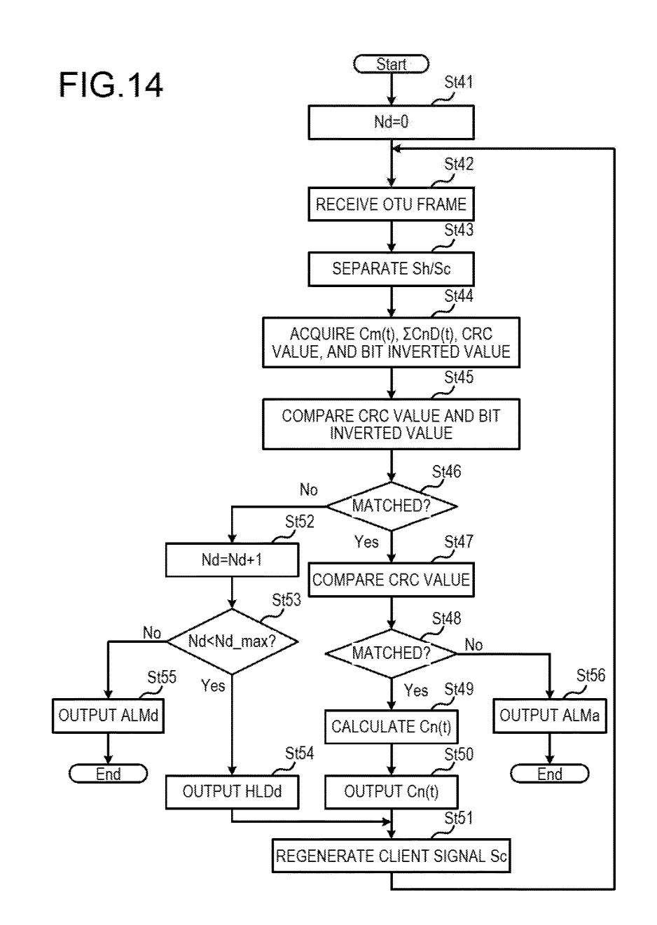

FIG. 14 is a flow chart illustrating a process of outputting an alarm according to the second embodiment. When the receiving side transmission devices 4a and 4b are started up, first, the CRC comparator 245 sets Nd to 0 (Operation St41). As described above, Nd is the number of times by which the CRC value is not equal to its bit inverted value.

Next, the O/E converter 20 receives an OTU frame Sf (Operation St42). Next, the de-mapper 21 separates an overhead Sh and a client signal Sc from the OTU frame Sf (Operation St43). Next, the information acquisition part 240 acquires a numerical value Cm(t), an accumulated value ΣCnD(t), and their CRC values, and a bit inverted value from the overhead Sh (Operation St44).

Next, the CRC comparator 245 compares the CRC value and the bit inverted value of each of the numerical value Cm(t) and the accumulated value ΣCnD(t) (Operation St45). As a result of the comparison, when it is determined that the CRC value and the bit inverted value of at least one of the numerical value Cm(t) and the accumulated value ΣCnD(t) are not equal to each other (No in Operation St46), the CRC comparator 245 adds 1 to the number of times of inequality Nd (Operation St52).

Next, the CRC comparator 245 compares the number of times of inequality Nd with the upper limit Nd_max (Operation St53). As a result of the comparison, when it is determined that Nd≧Nd_max (No in Operation St53), the CRC comparator 245 outputs the alarm ALMd to the network management device 7 (Operation St55). That is, when the number of times of inequality Nd reaches the upper limit Nd_max, the alarm ALMd is output.

As a result of the comparison, when it is determined that Nd<Nd_max (Yes in Operation St53), the CRC comparator 245 outputs the instruction signal HLDd to the oscillator 23 (Operation St54). Accordingly, the oscillator 23 maintains the current frequency without changing the frequency of the frequency signal f. Thereafter, the step of Operation St51 to be described later is performed.

Meanwhile, as a result of the comparison, when it is determined that the CRC value and the bit inverted value of both of the numerical value Cm(t) and the accumulated value ΣCnD(t) are equal to each other (Yes in Operation St46), the CRC checker 241 calculates a CRC value from the numerical value Cm(t) and compares the CRC value with the acquired CRC value while calculating a CRC value from the accumulated value ΣCnD(t) and comparing the CRC value with the acquired CRC value (Operation St47). That is, the CRC checker 241 performs a CRC check for the numerical value Cm(t) and the accumulated value ΣCnD(t).

When it is determined that a CRC value of at least one of the numerical value Cm(t) and the accumulated value ΣCnD(t) is not equal to the acquired CRC value (No in Operation St48), the CRC checker 241 outputs an alarm ALMa to the network management device 7 (Operation St56). When it is determined that the CRC value of both of the numerical value Cm(t) and the accumulated value ΣCnD(t) is equal to the acquired CRC value (Yes in Operation St48), the Cn calculator 243 calculates a numerical value Cn(t) from the numerical value Cm(t) and the accumulated value ΣCnD(t) (Operation St49).

Next, the Cn calculator 243 outputs the calculated numerical value Cn(t) to the oscillator 23 (Operation St50). Next, when the oscillator 23 outputs the frequency signal f to the E/O converter 22, the client signal Sc is regenerated (Operation St51). In this way, the process of outputting an alarm is performed.

Also in this embodiment, the network management device 7 performs the system switching process shown in FIG. 9. That is, when the alarms ALMa and ALMd are input, the network management device 7 switches the transmitting side transmission devices 3a and 3b and the receiving side transmission device 4a and 4b of the operation system which transmit/receive the OTU frame Sf. Accordingly, the network management device 7 may easily restore any error occurring in the numerical values Cn(t) and Cm(t) or the accumulated value ΣCnD(t).

As described above, the transmitting side transmission device 3a and 3b according to this embodiment includes the O/E converter 10, the mapper 11, the E/O converter 12, and the processor 13. The processor 13 includes the Cn calculator 130, the Cm calculator 131, the CnD calculator 132, and the overhead generator 133a.

The Cn calculator 130, the Cm calculator 131, and the CnD calculator 132 acquire the numerical values Cn(t) and Cm(t) and the accumulated value ΣCnD(t) related to the frequency of the client signal Sc from the client signal Sc. The overhead generator 133a calculates the CRC value of the numerical value Cm(t) and the accumulated value ΣCnD(t) acquired by the Cm calculator 131 and the CnD calculator 132. The overhead generator 133a generates the overhead Sh including the numerical value Cm(t) and the accumulated value ΣCnD(t), and the CRC value and the bit inverted value obtained by bit-inverting the CRC value.

The mapper 11 maps (multiplexes) the overhead Sh generated by the overhead generator 133a and the client signal Sc into the OTU frame Sf. The E/O converter 12 transmits the OTU frame Sf.

With the above-described configuration, the overhead generator 133a generates the overhead Sh including the numerical value Cm(t), the accumulated value ΣCnD(t), and their CRC values, and the bit inverted value. The E/O converter 12 transmits the OTU frame Sf into which the overhead Sh and the client signal Sc are mapped, to the receiving side transmission devices 4a and 4b.

Therefore, the receiving side transmission devices 4a and 4b may detect an error of the CRC value by comparing the CRC value and the bit inverted value acquired from the overhead Sh of the received OTU frame Sf, and may output the alarm ALMd. Accordingly, the network management device 7 may restore the error immediately by performing system switching in response to the alarm ALMd. As a result, with the transmitting side transmission devices 3a and 3b according to this embodiment, it is possible to shorten a time taken to restore an error of the client signal Sc due to a frequency deviation.

In addition, the transmission system according to this embodiment includes one set of redundant-configured transmitting side transmission devices 3a and 3b, one set of redundant-configured receiving side transmission devices 4a and 4b which are respectively connected to the one set of redundant-configured transmitting side transmission devices 3a and 3b, and the network management device 7. The network management device 7 manages the one set of transmitting side transmission devices 3a and 3b and the one set of receiving side transmission devices 4a and 4b.

Each of the transmitting side transmission devices 3a and 3b includes the O/E converter 10, the mapper 11, the E/O converter 12, and the processor 13. The processor 13 includes the Cn calculator 130, the Cm calculator 131, the CnD calculator 132, and the overhead generator 133a.

The Cn calculator 130, the Cm calculator 131, and the CnD calculator 132 acquire the numerical values Cn(t) and Cm(t) and the accumulated value ΣCnD(t) related to the frequency of the client signal Sc from the client signal Sc. The overhead generator 133a calculates the CRC value of the numerical value Cm(t) and the accumulated value ΣCnD(t) acquired by the Cm calculator 131 and the CnD calculator 132. The overhead generator 133a generates the overhead Sh including the numerical value Cm(t), the accumulated value ΣCnD(t), the CRC value, and the bit inverted value obtained by bit-inverting the CRC value.

The mapper 11 maps (multiplexes) the overhead Sh generated by the overhead generator 133a and the client signal Sc into the OTU frame Sf. The E/O converter 12 transmits the OTU frame Sf.

Each of the receiving side transmission devices 4a and 4b includes the O/E converter 20, the de-mapper 21, the E/O converter 22, the oscillator 23, and the processor 24. The processor 24 includes the information acquisition part 240a, the Cn calculator 243, and the CRC comparator 245.

The O/E converter 20 receives the OTU frame Sf. The de-mapper 21 separates the overhead Sh and the client signal Sc from the OTU frame Sf received by the O/E converter 20. The information acquisition part 240a acquires the numerical value Cm(t), the accumulated value ΣCnD(t), the CRC value, and the bit inverted value from the overhead Sh separated by the de-mapper 21. The Cn calculator 243 acquires the numerical value Cn(t) from the overhead Sh separated by the de-mapper 21. The E/O converter 22 and the oscillator 23 regenerate the client signal Sc separated by de-mapper 21 with a frequency based on the numerical value CnD(t) acquired by the Cn calculator 243.

The CRC comparator 245 compares the CRC value and the bit inverted value, and outputs the alarm ALMd to the network management device 7 in response to a result of the comparison. When the alarm ALMd is input from the CnD determination part 242 or the Cn determination part 244, the network management device 7 switches a transmitting side transmission device and a receiving side transmission device, which transmit/receive the OTU frame Sf, of the one set of transmitting side transmission devices 3a and 3b and the one set of receiving side transmission devices 4a and 4b.

Since the transmission system according to this embodiment includes the configuration such as, for example, the above-described transmitting side transmission devices 3a and 3b, this transmission system exhibits the acting effects as described above.

The transmission method according to this embodiment includes the following operations.
Operation (1): Acquiring the numerical values Cn(t) and Cm(t) and the accumulated value ΣCnD(t) related to the frequency of the client signal Sc from the client signal Sc
Operation (2): Calculating the CRC value of the acquired numerical value Cm(t) and accumulated value ΣCnD(t)
Operation (3): Generating the overhead Sh including the numerical value Cm(t), the accumulated value ΣCnD(t), the CRC value, and the bit inverted value obtained by bit-inverting the CRC value
Operation (4): Map the generated overhead Sh and the client signal Sc into the OTU frame Sf
Operation (5): Transmitting the OTU frame Sf

Since the transmission method according to this embodiment includes the configuration such as, for example, the above-described transmitting side transmission devices 3a and 3b, this transmission method exhibits the acting effects as described above.

The foregoing embodiments are described for the present disclosure. However, the present disclosure is not limited to the embodiments and may be modified in various ways without departing from the spirit and the scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A transmission device comprising:
a receiver configured to receive a frame into which control information and a data signal are mapped;
a de-mapper configured to de-map the control information and the data signal from the frame received by the receiver;
a hardware processor configured to
acquire a numerical value related to the frequency of the data signal from the control information de-mapped by the de-mapper, and
output an alarm in response to a variation of the numerical value for the frame; and
a regenerator configured to regenerate the data signal de-mapped by the de-mapper with a frequency based on the numerical value acquired by the hardware processor.

2. The transmission device according to claim 1, wherein the hardware processor counts a number of times by which the variation of the numerical value exceeds a predetermined value, and outputs the alarm when a number of times reaches a predetermined number of times.

3. The transmission device according to claim 2, wherein, when the number of times by which the variation of the numerical value exceeds the predetermined value is less than the predetermined number of times, the hardware processor instructs the regenerator to regenerate the data signal with a frequency based on the numerical value obtained when the variation of the numerical value is equal to or smaller than the predetermined value.

4. A transmission system comprising:
a pair of first transmission devices, each having a redundant system, and configured to include
a first hardware processor configured to
acquire a numerical value related to a frequency of a data signal, and
calculate an error detection code of the acquired numerical value and generate control information including the numerical value, the error correction code, and an inverted code obtained by bit-inverting the error detection code;
a mapper configured to map the control information generated by the generator and the data signal into a frame, and
a transmitter configured to transmit the frame;
a pair of second transmission devices, each having the redundant system, coupled with the pair of first transmission devices, respectively, and configured to include
a receiver configured to receive the frame into which the control information and the data signal are mapped, the frame being transmitted from the one of the pair of first transmission devices;
a de-mapper configured to de-map the control information and the data signal from the frame received by the receiver;
a second hardware processor configured to
acquire a numerical value related to the frequency of the data signal from the control information de-mapped by the de-mapper, and
output an alarm in response to a variation of the numerical value for the frame; and
a regenerator configured to regenerate the data signal de-mapped by the de-mapper with a frequency based on the acquired numerical value; and
a management device configured to control the pair of first transmission devices and the pair of second transmission devices so as to switch an operation state of a first transmission device of the pair of first transmission devices and a second transmission device of the pair of second transmission devices, which transmits and receives the frame, respectively, when the alarm is input from the second hardware processor.

5. The transmission system according to claim 4, wherein the second hardware processor counts a number of times by which the variation of the numerical value exceeds a predetermined value, and outputs the alarm when a number of times reaches a predetermined number of times.

6. The transmission system according to claim 5, wherein, when the number of times by which the variation of the numerical value exceeds the predetermined value is less than the predetermined number of times, the second hardware processor instructs the regenerator to regenerate the data signal with a frequency based on the numerical value obtained when the variation of the numerical value is equal to or smaller than the predetermined value.

7. A transmission method comprising:
acquiring a numerical value related to a frequency of a data signal;
calculating an error detection code of the numerical value;
generating control information including the numerical value, the error correction code, and an inverted code obtained by bit-inverting the error detection code;
mapping the control information and the data signal into a frame;
transmitting the frame;
receiving the frame into which control information and a data signal are mapped;
de-mapping the control information and the data signal from the received frame;
acquiring a numerical value related to the frequency of the data signal from the de-mapped control information;
regenerating the de-mapped data signal with a frequency based on the acquired numerical value; and
outputting an alarm in response to a variation of the numerical value for the frame.

8. The transmission method according to claim 7, wherein the outputting includes counting a number of times by which the variation of the numerical value exceeds a predetermined value and outputting the alarm when a number of times reaches a predetermined number of times.

9. The transmission method according to claim 8, wherein, when the number of times by which the variation of the numerical value exceeds the predetermined value is less than the predetermined number of times, the outputting includes instructing to reproduce the data signal with a frequency based on the numerical value obtained when the variation of the numerical value is equal to or smaller than the predetermined value.
